(19) United States
(12) Patent Application Publication
(10) Pub. No.: US 2008/0094164 A1
(43) Pub. Date: Apr. 24, 2008

(54) PLANAR TRANSFORMER

(75) Inventor: Tsun-Lai Hsu, Hsinchu Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: UNITED MICROELECTRONICS CORP., Hsinchu (TW)

(21) Appl. No.: 11/550,806

(22) Filed: Oct. 19, 2006

(51) Int. Cl. H01F 5/00

(52) U.S. Cl. 336/200

(57) ABSTRACT

A planar transformer including a first winding and a second winding is provided. The first winding includes a plurality of conductive paths and an electrical connection portion. The conductive paths of the first winding surround a position point. The electrical connection portion is electrically connected to the conductive paths of the first winding to form the first winding, wherein the electrical connection portion is disposed in a pad layer. The second winding also surrounds the position point.

### BACKGROUND OF THE INVENTION

1. Field of Invention

The present invention relates to a transformer. More particularly, the present invention relates to a layout of a planar transformer.

2. Description of Related Art

In certain application circuits, for example, radio circuits, usually one or more transformers are included. In the trend of light, thin, short, and small electronic products, the transformer in electronic circuits is usually required to be implemented in memory circuits. For example, the implementation of various transformers is respectively disclosed in U.S. Pat. Publication No. 4,816,784, No. 6,580,334, No. 6,608,364, and No. 6,927,664.

In consideration of an electromagnetic coupling efficiency, the conventional transformer substantially has a first winding (e.g. serving as the primary side) and a second winding (e.g. serving as the secondary side) alternatively disposed on the same plane. Therefore, the turn ratio of the first winding and the second winding of the conventional transformer can only be k:k or k:k+1 (k is a positive integer). FIG. 1 is a layout of the conventional transformer. A transformer 100 is symmetric with respect to a symmetrical line A, and also symmetric with respect to a symmetrical line B. The transformer 100 has a first winding 114 and a second winding 116, with the turn ratio of 1:1. In FIG. 1, the second winding 116 further has a central lead electrically connected to a center tap node CT of the second winding 116.

It is shown in FIG. 1 that the transformer 100 has two cross parts 118. Since the first winding 114 and the second winding 116 are alternatively disposed on the same plane, the two electrical paths (respectively for the first winding 114 and the second winding 116) that are not electrically connected to each other in the cross parts 118 are disposed in different planes. For example, when the first winding 114 and the second winding 116 are substantially alternatively disposed in the fourth metal layer, if the electrical path for the first winding 114 in the cross parts 118 is also disposed in the fourth metal layer, the electrical path for the second winding 116 in the cross parts 118 must be disposed in the third metal layer and connected to the second winding 116 of the fourth metal layer through the via. In the application of the radio circuit, the cross parts 118 may form an impedance.

FIG. 2 is a layout of another conventional transformer. A transformer 200 is symmetric with respect to a symmetrical line A. The transformer 200 has a first winding 214 and a second winding 216. As shown in the figure, since the first winding 214 (comprising windings R1, R3, and R5) and the second winding 216 (comprising windings R2 and R4) are alternatively disposed on the same plane, the turn ratio of the first winding 214 and the second winding 216 is 3:2 (i.e. k+1:k). In FIG. 2, the second winding 216 further has a central lead 224 electrically connected to a center tap node CT of the second winding 216. Without considering the central lead 224, the transformer 200 has five cross parts 226. In the application of the radio circuit, the cross parts 226 may form an impedance.

To sum up, in consideration of the electromagnetic coupling efficiency, the convention transformer must substantially have the first winding and the second winding alternatively disposed on the same plane. Therefore, the turn ratio of the first winding and the second winding of the conventional transformer can only be k:k or k:k+1 (k is a positive integer).

### SUMMARY OF THE INVENTION

Accordingly, an objective of the present invention is to provide a planar transformer, capable of alternatively arranging the first winding and the second winding on the same plane with any turn ratio.

Another objective of the present invention is to provide a planar transformer, making use of the connection part disposed on the bonding pad layer to flexibly determine the turn ratio of the transformer.

Still another objective of the present invention is to provide a planar transformer, making use of the connection part disposed on the pad layer to reduce the number of the cross parts between the transformer and the metal layer.

In view of the above objectives, the present invention provides a planar transformer, which comprises a first winding and a second winding. The first winding comprises a plurality of conductive paths and at least an electrical connection portion. The conductive paths of the first winding surround a position point. The electrical connection portion is electrically connected to the conductive paths of the first winding to form the first winding, wherein the electrical connection portion is disposed in a pad layer. The second winding also surrounds the position point.

The present invention further provides a planar transformer, which comprises a first winding and a second winding. The first winding and the second winding are substantially disposed on the top metal layer. The first winding comprises a plurality of conductive paths and at least an electrical connection portion. The conductive paths of the first winding and the second winding both surround a position point. The electrical connection portion is electrically connected to the conductive paths of the first winding to form the first winding. The electrical connection portion is disposed in the pad layer.

The present invention further provides a planar transformer, which comprises at least two windings. The windings surround the same position point, and a part of the electrical paths of the planar transformer are disposed in a pad layer.

In the planar transformer according to the preferred embodiment of the present invention, the first winding and the second winding are substantially disposed on the same plane.

In the planar transformer according to the preferred embodiment of the present invention, a lead electrically connected to the center tap node of one of the windings is further comprised.

In the planar transformer according to the preferred embodiment of the present invention, the windings are symmetric with respect to a symmetrical line, and the symmetrical line passes through the position point.

In the planar transformer according to the preferred embodiment of the present invention, the material of the pad layer comprises aluminum or aluminum compound.

In the present invention, since the connection part is disposed in the pad layer, the turn ratio of the transformer can be flexibly determined. The planar transformer of the present invention has the first winding and the second winding alternatively disposed on the same plane with any turn ratio. The present invention makes use of the connection part disposed on the pad layer to reduce the number of the cross parts between the transformer and the metal layer.

In order to make the aforementioned and other objects, features and advantages of the present invention comprehensible, preferred embodiments accompanied with figures are described in detail below.

### BRIEF DESCRIPTION OF THE DRAWINGS

FIG. 1 is a layout of a conventional transformer with the turn ratio of 1:1.

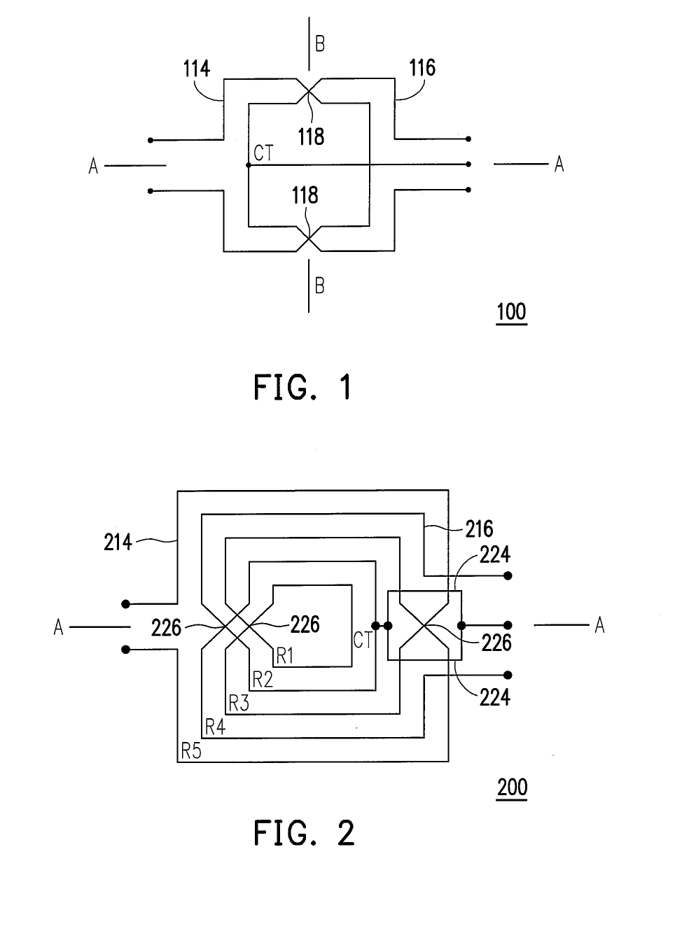

FIG. 2 is a layout of another conventional transformer with the turn ratio of 3:2.

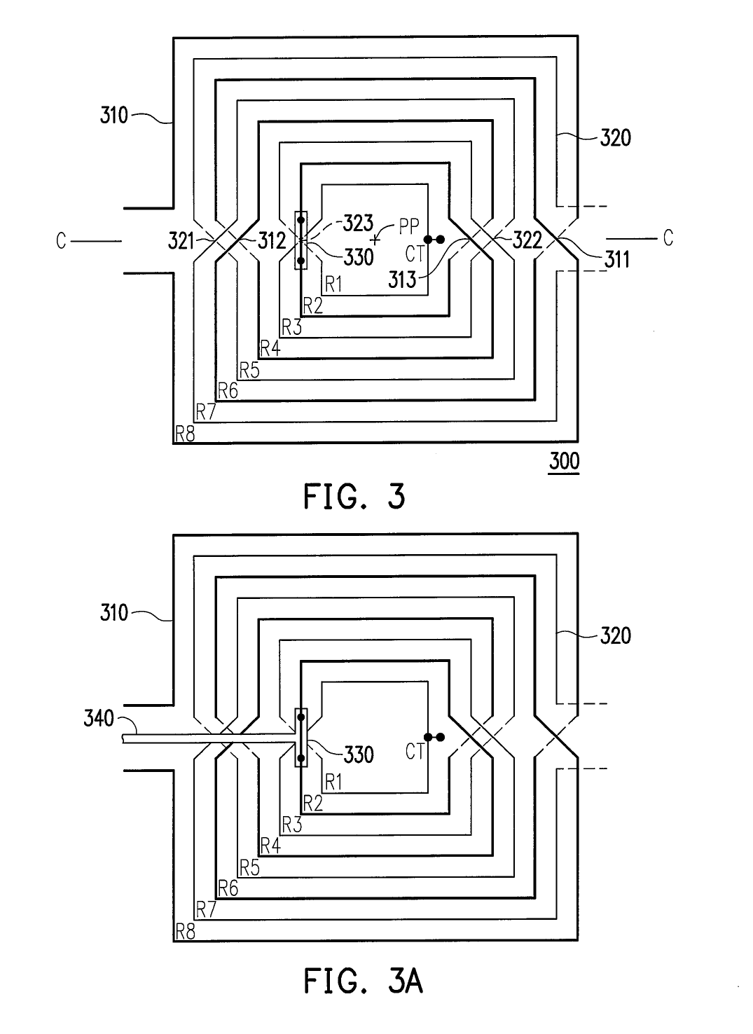

FIG. 3 is a planar transformer with the turn ratio of 4:4 according to an embodiment of the present invention.

FIGS. 3A˜3C are the planar transformer of FIG. 3 according to other embodiments of the present invention.

FIG. 4 is a planar transformer with the turn ratio of 3:4 according to an embodiment of the present invention.

FIGS. 4A˜4C are the planar transformer of FIG. 4 according to other embodiments of the present invention.

FIG. 5 is a planar transformer with the turn ratio of 2:4 according to an embodiment of the present invention.

FIGS. 5A˜5C are the planar transformer of FIG. 5 according to other embodiments of the present invention.

FIG. 6 is a planar transformer with the turn ratio of 1:4 according to an embodiment of the present invention.

FIGS. 6A˜6C are the planar transformer of FIG. 6 according to other embodiments of the present invention.

### DESCRIPTION OF EMBODIMENTS

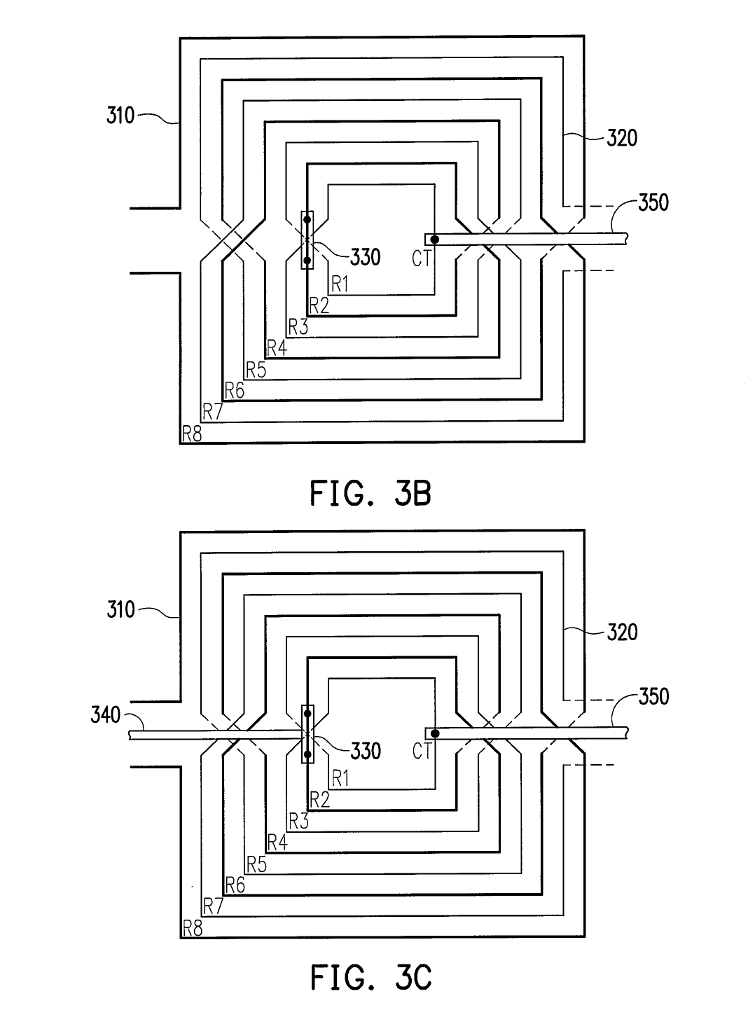

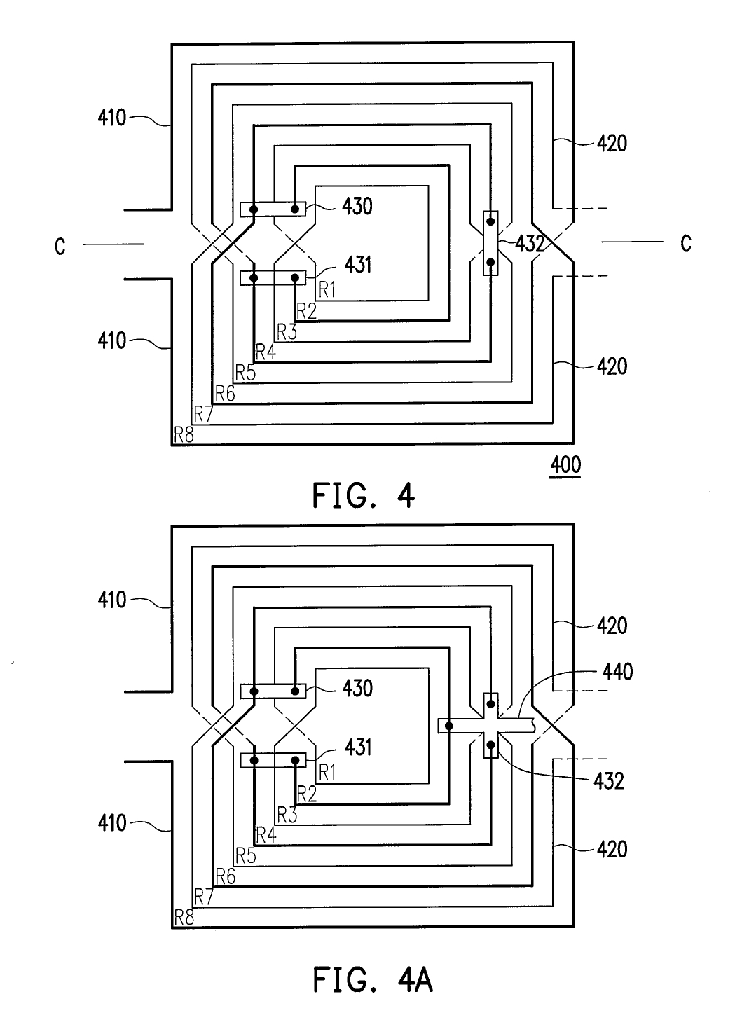

For the convenience of illustration, the planar transformer as shown in FIG. 3 with the turn ratio of k:k is taken as an example. However, the implementation of the present invention is not limited herein. Moreover, in order to illustrate the present invention being capable of flexibly determining the turn ratio of the transformer, the first winding and the second winding are alternatively disposed on the same plane. The following embodiments are modified based on the symmetric shape of FIG. 3, thus proving that the present invention can make use of the connection part disposed in the pad layer to achieve the function of flexibly determining any turn ratio. Any planar transformer with the symmetric shape can be deduced by those of ordinary skill in the art according to the spirit of the present invention and the teaching of the following embodiments.

FIG. 3 is a planar transformer with the turn ratio of 4:4 according to an embodiment of the present invention. Referring to FIG. 3, a planar transformer 300 comprises a first winding 310 and a second winding 320. In the figure, the lines of different thickness are used to indicate the first winding 310 and the second winding 320, and the thickness of the line in the figure is not intended to illustrate the thickness of the metal line of the planar transformer 300 in the actual layout.

The winding 310 comprises conductive paths R2, R4, R6, and R8, and the winding 320 comprises conductive paths R1, R3, R5, and R7. The conductive paths R1˜R8 surround a position point PP. Herein, the winding 310 and the winding 320 are substantially alternatively disposed on the same plane, as shown in FIG. 3. The winding 310 and the winding 320 are symmetric with respect to the symmetrical line C, and the symmetrical line C passes through the position point PP.

In consideration of the coupling effect of the transformer 300 and the substrate, the distance between the transformer 300 and the substrate must be extended as much as possible. In the present embodiment, the winding 310 and the winding 320 are, for example, disposed in the top metal layer.

Since the winding 310 and the winding 320 are alternatively disposed on the same plane and the winding 310 and the winding 320 are not electrically connected to each other, the cross parts 311, 312, 313, 321, 322, and 323 are disposed in the transformer 300. In each of the cross parts, two electrical paths that are not electrically connected to each other must be disposed in the different planes. For example, when the first electrical path (connected to the conductive path R6) of the cross part 311 is disposed on the top metal layer, the second electrical path (connected to the conductive path R8) of the cross part 311 is disposed in the metal layer beneath the top metal layer, and the second electrical path of the cross part 311 is connected to the conductive path R8 in the top metal layer through the via.

In the present embodiment, the first winding 310 further comprises an electrical connection portion 330. The electrical connection portion 330 is disposed in the pad layer. The pad layer is disposed above the top metal layer. Usually, the pad layer is used to form the bonding pad. The material of the pad layer can be different from that of the metal layers thereunder. For example, the material of the metal layers can be copper (or copper compound), and the material of the pad layer can be aluminum or aluminum compound. Since the electrical connection portion 330 is disposed in the pad layer, the efficiency of the planar transformer 300 is not affected. The electrical connection portion 330 is electrically connected to the conductive paths R2 and R4, thus forming the complete first winding 310.

As required, a central lead is disposed in the first winding 310 or the second winding 320 of the transformer 300. For example, a first lead 340 is disposed to make the lead being electrically connected to the center tap node of the first winding 310 (herein, the center tap node is just at the electrical connection portion 330), as shown in FIG. 3A. Also, a second lead 350 can be disposed to make the lead being electrically connected to the center tap node of the second winding 320 (e.g. CT in the figure), as shown in FIG. 3B. Definitely, central leads 340 and 350 can be respectively disposed in the first winding 310 and the second winding 320 of the transformer 300, as shown in FIG. 3C. In the present embodiment, the center tap nodes of the first winding 310 and the second winding 320 are just on the symmetrical line C.

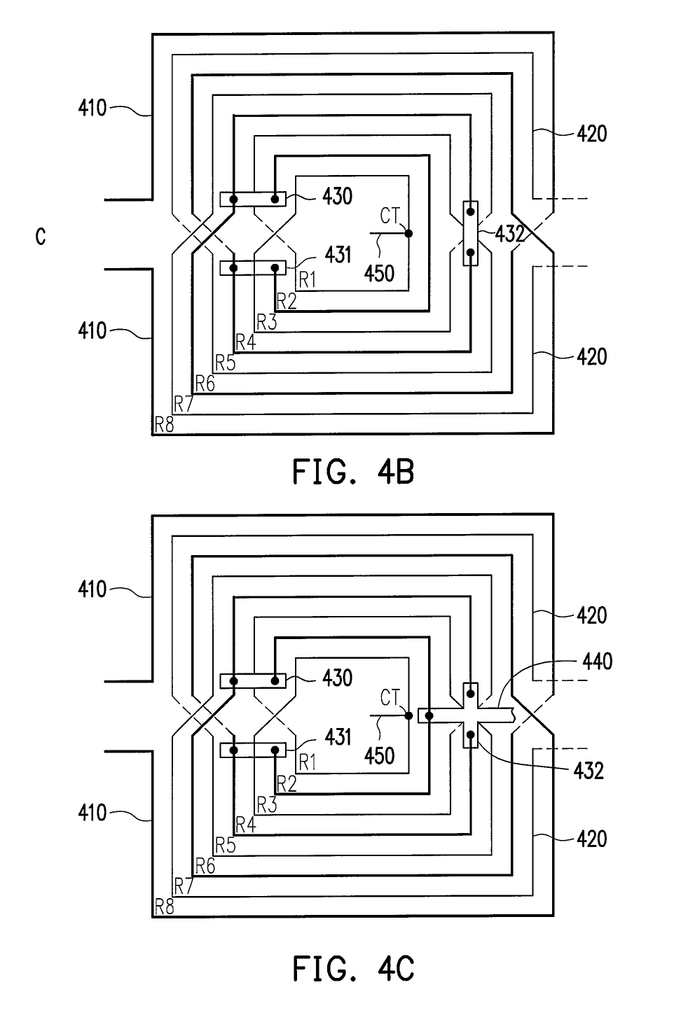

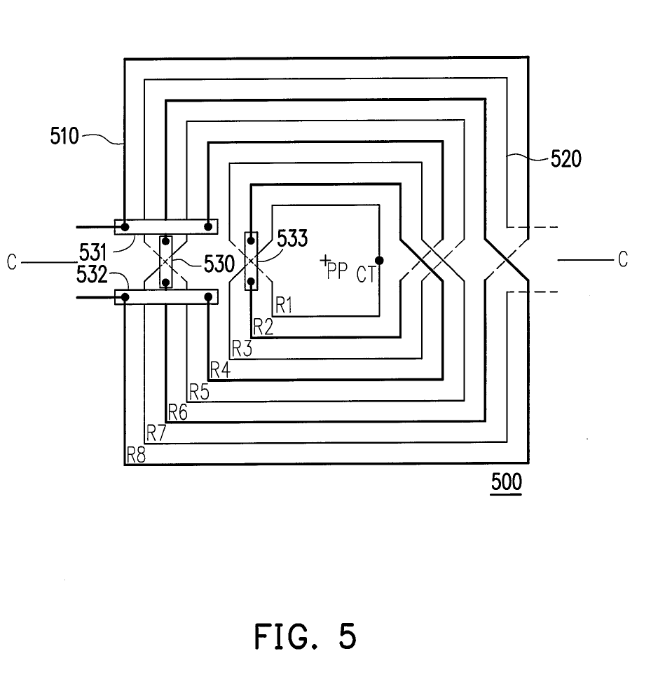

FIG. 4 is a planar transformer with the turn ratio of 3:4 according to an embodiment of the present invention. In the present embodiment, the symmetric shape of FIG. 3 is modified, and the intricate connection of the electrical connection portion disposed in the pad layer is used to change the turn ratio. Referring to FIG. 4, a planar transformer 400 comprises a first winding 410 and a second winding 420. The details that are not illustrated in the present embodiment can refer to those of FIG. 3 and the preceding embodiment. In FIG. 4, the lines of different thickness are used to indicate the first winding 410 and the second winding 420, and the thickness of the line in the figure is not intended to illustrate the thickness of the metal line of the planar transformer 400 in the actual layout.

The winding 410 comprises the conductive paths R2, R4, R6, and R8, and the winding 420 comprises the conductive paths R1, R3, R5, and R7. As shown in FIG. 4, it is apparent that the winding 410 and the winding 420 are substantially alternatively disposed on the same plane. In the present embodiment, the winding 410 and the winding 420 are substantially disposed in the top metal layer.

In the present embodiment, the first winding 410 further comprises the electrical connection portions 430, 431 and 432. The electrical connection portions 430 and 431 are disposed in the pad layer. Since the electrical connection portions 430 and 432 are disposed in the pad layer, the efficiency of the planar transformer 400 is not affected. The electrical connection portions 432 are electrically connected to the conductive paths R4, and the electrical connection portions 430 and 431 are electrically connected to the conductive paths R2, and R4, thus forming the complete first winding 410 (the number of turns is 3).

As required, a central lead is disposed in the first winding 410 or the second winding 420 of the transformer 400. For example, a first lead 440 is disposed to make the lead being electrically connected to the center tap node of the first winding 410 (herein, the center tap node is just at the electrical connection portion 430), as shown in FIG. 4A. Also, a second lead 450 can be disposed to make the lead being electrically connected to the center tap node of the second winding 420 (e.g. CT in the figure), as shown in FIG. 4B. Definitely, central leads 440 and 450 can be respectively disposed in the first winding 410 and the second winding 420 of the transformer 400, as shown in FIG. 4C. In the present embodiment, the center tap nodes of the first winding 410 and the second winding 420 are just on the symmetrical line C.

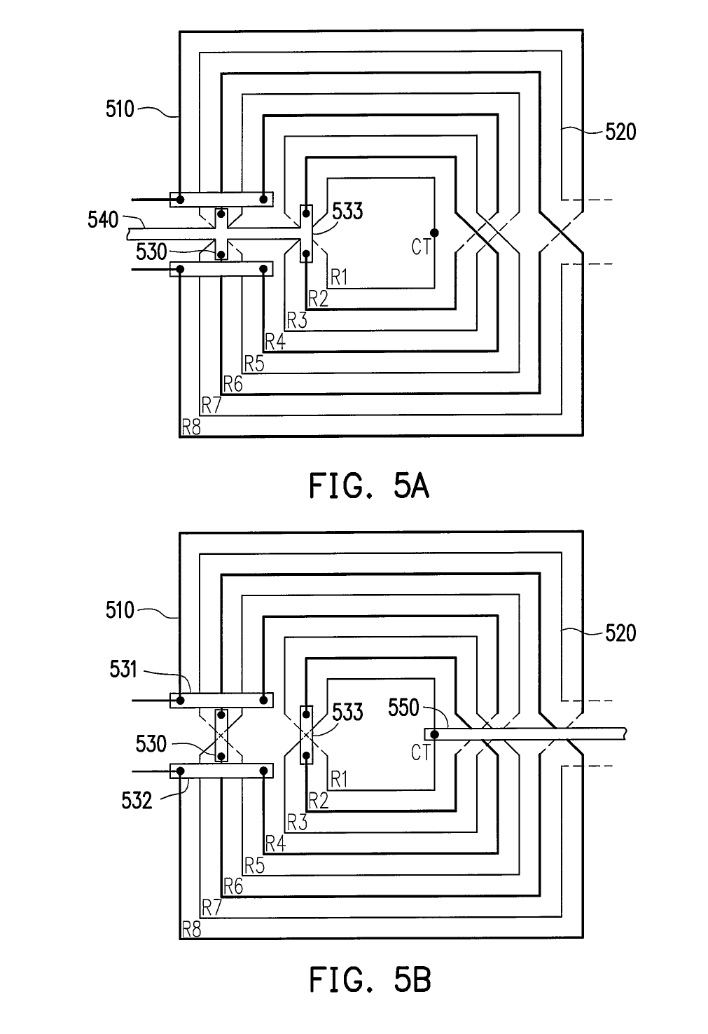

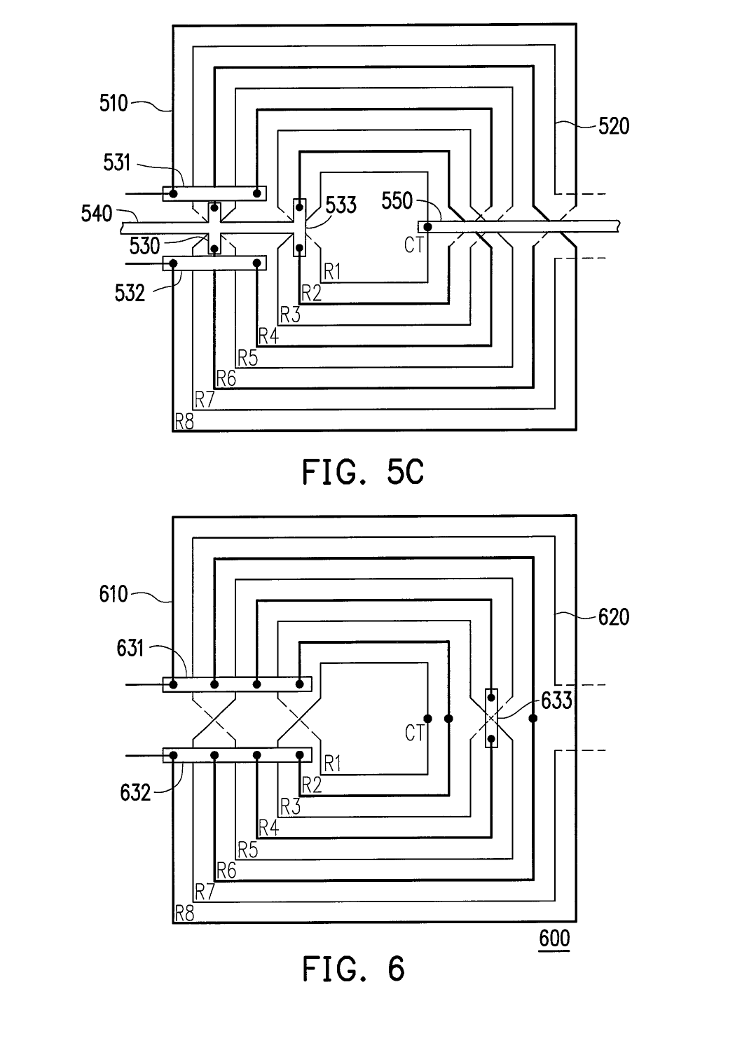

FIG. 5 is a planar transformer with the turn ratio of 2:4 according to an embodiment of the present invention. In the present embodiment, the symmetric shape of FIG. 3 is modified, and the intricate connection of the electrical connection portion disposed on the pad layer is used to change the turn ratio. Referring to FIG. 5, a planar transformer 500 comprises a first winding 510 and a second winding 520. The details that are not illustrated in the present embodiment can refer to those of FIG. 3 and the above embodiment.

The winding 510 comprises the conductive paths R2, R4, R6, and R8, and the winding 520 comprises the conductive paths R1, R3, R5, and R7. As shown in FIG. 5, it is apparent that the winding 510 and the winding 520 are substantially alternatively disposed on the same plane. In the present embodiment, the winding 510 and the winding 520 are substantially disposed in the top metal layer.

In the present embodiment, the first winding 510 further comprises the electrical connection portions 530, 531, 532, and 533. The electrical connection portions 530˜533 are disposed in the pad layer. Since the electrical connection portions 530˜533 are disposed in the pad layer, the efficiency of the planar transformer 500 is not affected. The electrical connection portion 530 is electrically connected to the conductive paths R6 and R8, the electrical connection portion 531 is electrically connected to the conductive paths R6 and R2, the electrical connection portion 532 is electrically connected to the conductive paths R4 and R8, and the electrical connection portion 533 is electrically connected to the conductive paths R2 and R4, thus forming the complete first winding 510 (the number of turns is 2).

As required, the central lead can be disposed in the first winding 510 or the second winding 520 of the transformer 500. For example, the first lead 540 is disposed to make the lead being electrically connected to the center tap node of the first winding 510 (herein, the center tap node is just at the electrical connection portion 533), as shown in FIG. 5A. Also, the second lead 550 can be disposed to make the lead being electrically connected to the center tap node of the second winding 520 (e.g. CT in the figure), as shown in FIG. 5B. Definitely, the central leads 540 and 550 are respectively disposed in the first winding 510 and the second winding 520 of the transformer 500, as shown in FIG. 5C.

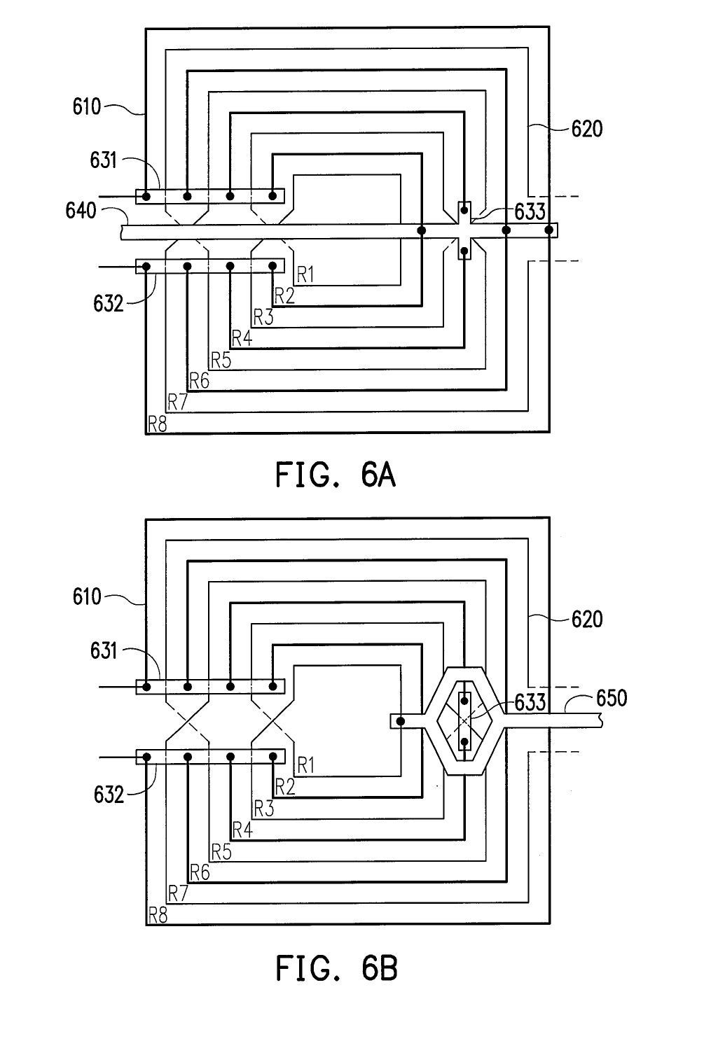

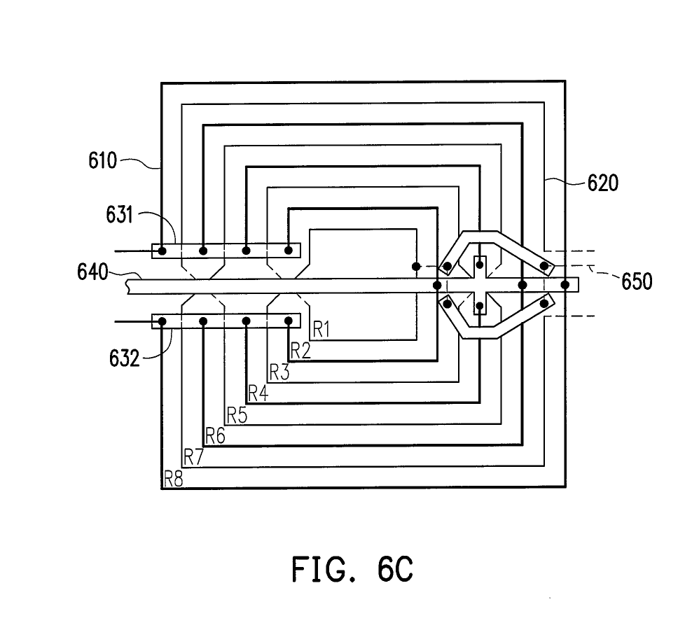

FIG. 6 is a planar transformer with the turn ratio of 1:4 according to an embodiment of the present invention. In the present embodiment, the symmetric shape of FIG. 3 is modified, and the intricate connection of the electrical connection portion disposed in the pad layer is used to change the turn ratio. Referring to FIG. 6, the planar transformer 600 comprises a first winding 610 and a second winding 620. The details that are not illustrated in the present embodiment can refer to those of FIG. 3 and the above embodiment.

The winding 610 comprises the conductive paths R2, R4, R6, and R8, and the winding 620 comprises the conductive paths R1, R3, R5, and R7. As shown in FIG. 6, it is apparent that the winding 610 and the winding 620 are substantially alternatively disposed on the same plane. In the present embodiment, the winding 610 and the winding 620 are substantially disposed in the top metal layer.

In the present embodiment, the first winding 610 further comprises the electrical connection portions 631, 632, and 633. The electrical connection portions 631˜633 are disposed in the pad layer. Since the electrical connection portions 631˜633 are disposed in the pad layer, the efficiency of the planar transformer 600 is not affected. The electrical connection portions 631 and 632 are electrically connected to the conductive paths R2, R4, R6, and R8, thus forming the complete first winding 610 (the number of turns is 1).

As required, the central lead can be disposed in the first winding 610 or the second winding 620 of the transformer 600. For example, the first lead 640 is disposed to make the lead being electrically connected to the center tap node of the first winding 610 (herein, the center tap node is just at the electrical connection portion 633), as shown in FIG. 6A. Also, the second lead 650 can also be disposed to make the lead being electrically connected to the center tap node of the second winding 620 (e.g. CT in the figure), as shown in FIG. 6B. Definitely, the central leads 640 and 650 are respectively disposed in the first winding 610 and the second winding 620 of the transformer 600, as shown in FIG. 6C.

To sum up, the present invention makes use of the connection part disposed in the pad layer to flexibly determine the turn ratio of the transformer. In the planar transformer of the present invention, the first winding and the second winding can be alternatively disposed on the same plane with any turn ratio. In the present invention, the connection part disposed in the pad layer can also be used to reduce the number of the cross parts between the transformer and the metal layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A planar transformer, comprising:
a first winding, comprising:
a plurality of conductive paths, wherein the conductive paths of the first winding surround a position point; and
an electrical connection portion, electrically connected to the conductive paths of the first winding to form the first winding, wherein the electrical connection portion is disposed in a pad layer; and
a second winding, insulated from the first winding, wherein the second winding surrounds the position point.

2. The planar transformer as claimed in claim 1, wherein the first winding and the second winding are substantially disposed on the same plane.

3. The planar transformer as claimed in claim 2, wherein the first winding and the second winding are symmetric with respect to a symmetrical line, and the symmetrical line passes through the position point.

4. The planar transformer as claimed in claim 1, wherein the material of the pad layer comprises aluminum or aluminum compound.

5. The planar transformer as claimed in claim 1, wherein the first winding further comprises:
a first lead, electrically connected to the center tap node of the winding formed by the conductive paths and the electrical connection portion of the first winding.

6. The planar transformer as claimed in claim 5, wherein the first winding is symmetric with respect to a symmetrical line, and the symmetrical line passes through the position point and the center tap node.

7. The planar transformer as claimed in claim 1, wherein the second winding comprises:
a second lead, electrically connected to the center tap node of the second winding.

8. The planar transformer as claimed in claim 7, wherein the second winding is symmetric with respect to a symmetrical line, and the symmetrical line passes through the position point and the center tap node.

9. A planar transformer, comprising:
a first winding, comprising:
a plurality of conductive paths, wherein the conductive paths of the first winding surround a position point; and
an electrical connection portion, electrically connected to the conductive paths of the first winding to form the first winding, wherein the electrical connection portion is disposed in a pad layer; and
a second winding, insulated from the first winding, wherein the second winding surrounds the position point;
wherein the first winding and the second winding are substantially disposed on the top metal layer.

10. The planar transformer as claimed in claim 9, wherein the first winding and the second winding are symmetric with respect to a symmetrical line, and the symmetrical line passes through the position point.

11. The planar transformer as claimed in claim 9, wherein the material of the pad layer comprises aluminum or aluminum compound.

12. The planar transformer as claimed in claim 9, wherein the first winding further comprises:
a first lead, electrically connected to the center tap node of the winding formed by the conductive paths and the electrical connection portion of the first winding.

13. The planar transformer as claimed in claim 12, wherein the first winding is symmetric with respect to a symmetrical line, and the symmetrical line passes trough the position point and the center tap node.

14. The planar transformer as claimed in claim 9, wherein the second winding comprises:
a second lead, electrically connected to the center tap node of the second winding.

15. The planar transformer as claimed in claim 14, wherein the second winding is symmetric with respect to a symmetrical line, and the symmetrical line passes trough the position point and the center tap node.

16. A planar transformer, comprising at least two windings, wherein one of the windings is insulated from the other winding, the windings surround the same position point, and a part of the electrical paths of the planar transformer is disposed in a pad layer.

17. The planar transformer as claimed in claim 16, wherein the windings are substantially disposed on the same plane.

18. The planar transformer as claimed in claim 17, wherein the windings are substantially disposed on the top metal layer.

19. The planar transformer as claimed in claim 17, wherein the windings are symmetric with respect to a symmetrical line, and the symmetrical line passes through the position point.

20. The planar transformer as claimed in claim 16, wherein the material of the pad layer comprises aluminum or aluminum compound.

21. The planar transformer as claimed in claim 16, further comprising:
a lead, electrically connected to the center tap node of one of the windings.

22. The planar transformer as claimed in claim 21, wherein the windings are symmetric with respect to a symmetrical line, and the symmetrical line passes through the position point and the center tap node.
